(19) United States
(12) Patent Application Publication
(10) Pub. No.: US 2011/0293504 A1
(43) Pub. Date: Dec. 1, 2011

(54) PROCESS FOR PRODUCING CARBON NANOTUBES (CNTs)

(76) Inventors: Abdul Rahman Mohamed, Pulau Pinang (MY); Siang Piao Chai, Pulau Pinang (MY)

(21) Appl. No.: 13/127,862

(22) PCT Filed: Nov. 18, 2008
(86) PCT No.: PCT/MY08/00143

§ 371 Date: Aug. 8, 2011

(51) Int. Cl. D01F 9/12; B82Y 40/00; B82Y 30/00

(52) U.S. Cl. 423/447.3; 977/742; 977/843; 977/752

(57) ABSTRACT

The present invention provides a process for producing substantially uniform-sized carbon nanotubes (CNTs), the process includes the step of contacting methane with catalytic particles at a temperature of between 650 to 850° C.

### FIELD OF INVENTION

The present invention is relates to a process for producing carbon nanotubes (CNTs).

### BACKGROUND OF INVENTION

In the year 1991, Sumio Iijima discovered a new form of carbon species named as carbon nanotubes. Carbon nanotubes are seamless tubes comprise of graphene sheets rounded up in a hollow form with full fullerene caps. There are two general types of carbon nanotubes, referred to as multi-walled single-walled carbon nanotubes (SWNTs) and carbon nanotubes (MWNTs). SWNTs are theoretically one-atom-thick shell of hexagonally-arranged carbon atoms rolled into cylindrical sheet-like, meanwhile MWNTs composed of multiple coaxial cylinders with increasing diameter around a common axis.

There are generally three technologies have been applied in the synthesis of carbon nanotubes. They are carbon-arc discharge, laser-ablation and chemical vapor deposition (CVD). The former two methods were designed mainly for carbon nanotubes synthesis on laboratory scale and were used primarily for theoretical investigation. Catalytic CVD is widely recognized as the most attractive method due to its potential for large-scale production of carbon nanotubes as this process has a better control over the properties of carbon nanotubes synthesized by manipulate the reaction conditions.

Carbon nanotubes, the most advanced materials in this era, are posting remarkable mechanical properties with theoretical Young's modulus and tensile strength as high as 1 TPa and 200 GPa, which is stronger than stainless steel (1.5 GPa). Carbon nanotubes are highly chemical inert and able to sustain a high strain (10-30%) without breakage. Moreover, the nanotubes own high thermal and electrical conductivities for better than copper enabling them to reinforce tiny structures with bearing a dual function of reinforcement and signal transmitting of composite circuit board. It can be foreseen that nanotube-related structures could be designed as advanced materials for the applications such as quantum wires, flat panel displays, rechargeable batteries, memory chips, structural reinforcements, biomedical applications, catalyst support and so on in the near future.

In order to put these potential applications into practice, carbon nanotubes with uniform diameters are required. This is due to the properties of carbon nanotubes (metallic, semiconducting and mechanical properties) depend strongly on their chirality and diameter. Both distinctive characteristic of carbon nanotubes have great impact on their important applications. Chirality has a close correlation with carbon nanotubes diameter. See Odom et al., “Atomic structure and electronic properties of single-walled carbon nanotubes,” Nature, Vol. 391, p. 62 (1998); Saito et al. “Electronic structure of chiral graphene tubules,” Appl. Phys. Lett., Vol 60, p. 2204 (1992); Reich et al., “Carbon nanotubes: basic, concepts and physical properties,” Germany:Wiley-VCH, Chap. 3 (2004). Therefore, by controlling the diameter uniformity of carbon nanotubes, one can also control their chirality and thus their properties.

The size of metallic particles in the catalytic materials determines the diameter of the produced carbon nanotubes. See Vander et al., “Substrate-support interaction in metal-catalyzed carbon nanofibers growth,” Carbon, Vol 39, p. 2277 (2001); Takenaka et al., “Ni/SiO₂ catalyst effective for methane decomposition into hydrogen and carbon nanofibers,” J. Catal, Vol 217, p. 79 (2003). Consequently, by narrow down the size distribution of the metallic particles of catalysts used in CVD process, carbon nanotubes with uniform diameters can be synthesized.

Although many effective ways of producing CNTs with nearly uniform diameters have been suggested in the literature, these approaches involve either complicated procedures in preparing catalyst or sophisticated equipment usage. It is known that CNTs of nearly uniform diameter is required in the near future for application purpose. Thus, a simple and convenient way to synthesize CNTs of nearly uniform diameter should be established.

### SUMMARY OF INVENTION

Accordingly, there is provided a process for producing a substantially uniform-sized carbon nanotubes (CNTs), the process includes the step of contacting a gas selected from a group of methane, ethylene or acetylene, individually or any combination thereof with catalytic particles comprising a support upon which Co and Mo are deposited, wherein the ratio of Co and Mo (Co:Mo) is between 1:0 to 2:3 (w/w), further wherein the step of contacting is conducted at a temperature of between 650 to 850° C.

The present invention consists of several novel features and a combination of parts hereinafter fully described and illustrated in the accompanying description, it being understood that various changes in the details may be made without departing from the scope of the invention or sacrificing any of the advantages of the present invention.

### DETAILED DESCRIPTION OF THE PREFERRED EMBODIMENTS

The present invention is relates to a process for producing CNTs. Hereinafter, this specification will describe the present invention according to the preferred embodiments of the present invention. However, it is to be understood that limiting the description to the preferred embodiments of the invention is merely to facilitate discussion of the present invention and it is envisioned that those skilled in the art may devise various modifications and equivalents without departing from the scope of the appended claims.

As mentioned earlier, the present invention provides a process for producing a substantially uniform-sized CNTs, the process includes the step of contacting a gas selected from a group of methane, ethylene or acetylene, individually or any combination thereof with catalytic particles comprising a support upon which Co and Mo are deposited, wherein the ratio of Co and Mo is between (Co:Mo) is between 1:0 to 2:3 (w/w), further wherein the step of contacting is conducted at a temperature of between 650 to 850° C.

The process can be summarized as follows:

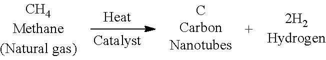

Preferably, the CNTs produced using the process of the present invention are multi-walled CNTs of a diameter of between 6 to 14 nm, preferably 9.0±1.4 nm (mean±standard deviation).

In the preferred embodiments of the present invention, the process is conducted in a reactor. In such reactor, the reaction time is about 30 minutes to about 180 minutes and the pressure within the reactor is between 0.1 to 3 atm, preferably 1 atm. The reaction temperature is between 650 to 850° C.

The gas used to produce the CNTs is methane. However, in the preferred embodiments of the present invention, methane gas can be mixed with a diluent gas selected from a group consisting of nitrogen, argon or helium, individually or a combination thereof.

The diluent gas is preferably nitrogen. Methane and nitrogen gases are mixed with a volumetric ratio of CH₄ to N₂ (CH₄:N₂) ranging from about 1:0 to about 1:9. The mixture of methane and nitrogen gases is fed continuously to the reactor with a flow rate of from about 20 ml/min to about 150 ml/min.

The catalytic particles deposited on the support comprises from about 5% to about 20% by weight of Co and Mo. Preferably, the ratio of Co and Mo is 8:2 (w/w). The support is selected from a group of silica, H-ZSM-5, titania, magnesia, ceria and alumina, individually or any combination thereof, preferably alumina.

The present invention is a single-step production of CNTs by adopting a simple catalytic decomposition process, using natural gas as feedstock in a CVD process. This technology is applying a low cost process with a catalyst as an enhancement agent to decompose natural gas into CNTs and hydrogen. In addition, this developed technology is easy to be scaling up at a large-scale of CNTs production.

It is of importance to mention that the catalyst is efficient in enhancing the formation of CNTs in the catalytic decomposition process. In this process, the carbon atoms, decomposed from natural gas, will deposit on the active site of a special designed catalyst and self-assemble to form tubular nanocarbon structure, which are CNTs.

The present invention is a simple single-step process, utilizing cheaper and abundant natural gas as a feedstock, can be operated by single operator, one of the cheapest if not the cheapest process for CNTs production, scalable to any production size, produces high purity CNTs and hydrogen without undesirable by-products and requires one of the lowest if not the lowest energy requirement which is approximately 60 kJ/mol only.

1. A process for producing a substantially uniform-sized carbon nanotubes, the process comprising the step of:
contacting a gas selected from a group consisting of methane, ethylene or acetylene, individually or any combinations thereof with catalytic particles Co and Mo deposited upon a support,
wherein a ratio of Co to Mo (Co:Mo) is between 1:0 to 2:3 (w/w), and
wherein the step of contacting is conducted at a temperature between 650 to 850° C.

2. The process as claimed in claim 1, wherein the carbon nanotubes produced are multi-walled carbon nanotubes having a diameter of between 6 to 14 nm.

3. The process as claimed in claim 1, wherein the process is conducted in a reactor.

4. The process as claimed in claim 3, wherein the reaction time is about 30 minutes to about 180 minutes.

5. The process as claimed in claim 3, wherein a pressure within the reactor is between 0.1 to 3 atm.

6. The process as claimed in claim 3, wherein the gas is methane.

7. The process as claimed in claim 6, wherein methane further comprises a diluent gas selected from a group consisting of nitrogen, argon, or helium, individually or a combination thereof.

8. The process as claimed in claim 6, wherein methane and nitrogen gases are mixed with a volumetric ratio of CH₄ to N₂ (CH₄:N₂) ranging from about 1:0 to about 1:9.

9. The process as claimed in claim 8, wherein the mixture of methane and nitrogen gases is fed continuously to the reactor with a flow rate of from about 20 ml/min to about 150 ml/min.

10. The process as claimed in claim 1, wherein the catalytic particles deposited on the support comprises from about 5% to about 20% by weight of Co and Mo.

11. The process as claimed in claim 10, wherein the support is selected from a group consisting of silica, H-ZSM-5, titania, magnesia, ceria and alumina, individually or any combinations thereof.

12. The process as claimed in claim 11, wherein the support is alumina.

13. (canceled)

14. The process as claimed in claim 2, wherein the diameter is 9 nm±1.4 nm (mean±standard deviation).

15. The process as claimed in claim 5, wherein the pressure is 1 atm.

16. The process as claimed in claim 7, wherein the diluent gas is nitrogen.
